(19) United States
(12) Patent Application Publication
(10) Pub. No.: US 2005/0047766 A1
(43) Pub. Date: Mar. 3, 2005

(54) Infrared radiation source, use of same, and a method for its manufacture

(76) Inventors: Sven Linow, Darmstadt (DE); Werner Kreuter, Hanau (DE); Stefan Fuchs, Niedernberg (DE)

Correspondence Address: FULBRIGHT & JAWORSKI, LLP, 666 FIFTH AVE, NEW YORK, NY, 10103-3198, US

(21) Appl. No.: 10/880,066

(22) Filed: Jun. 29, 2004

(30) Foreign Application Priority Data
Aug. 27, 2003 (DE) 103 39 756.6
Oct. 4, 2003 (DE) 103 46 101.9

(51) Int. Cl. H01F 27/08

(52) U.S. Cl. 392/407

(57) ABSTRACT

The invention relates to an infrared radiation source having a long, gas-tight casing tube made of quartz glass, and a heat conductor made of carbon which is situated in the casing tube, the heat conductor being electrically connected to at least two electrical contacts outside the casing tube and being situated at a distance from the casing tube by at least one spacer element and being centered therein, and is characterized in that the heat conductor is designed as a long strip and that the at least one spacer element is designed as a disk, whereby the disk has an opening for passing the heat conductor through, the disk at least partially fills the open cross section between the heat conductor and the casing tube, and the disk is made of carbon fiber-reinforced carbon (CFC).

The invention relates to an infrared radiation source having a long, gas-tight casing tube made of quartz glass, and a heat conductor made of carbon which is situated in the casing tube, the heat conductor being electrically connected to at least two electrical contacts outside the casing tube and being situated at a distance from the casing tube by at least one spacer element made of carbon and being centered therein, whereby the heat conductor is designed as a long strip. The invention further relates to the use of such an infrared radiation source and to a method for manufacturing same.

Infrared radiation sources of the aforementioned type are known from U.S. Pat. No. 6,057,532. An infrared radiation source having a strip-shaped heating element containing carbon fibers is disclosed therein. The heating element is centered in a casing tube made of quartz glass and is separated at a distance from the walls of the casing tube by spacer elements. As spacer elements, on the one hand a yoke is used which is fixed to nibs molded onto the inner wall of the casing tube. The production of the yoke as such and the molding of the nibs onto the inner wall of the casing tube are very complicated and therefore costly. On the other hand, spacer elements are used in the form of a cotter pin which is inserted through the strip-shaped heating element and fixed in the casing tube, once again by the use of nibs. Such a design very quickly results in failure of the heating element once the strip in the region of the cotter pins disintegrates.

The object of the present invention is to provide an infrared radiation source which has a heat conductor made of carbon having more suitable spacer elements between the heat conductor, and having a casing tube made of quartz glass, and to provide an optimized method for the manufacture of same.

The object is achieved by designing the at least one spacer element as a disk, whereby the disk has an opening for passing the heat conductor through, and the disk at least partially fills the open cross section between the heat conductor and the casing tube.

Such spacer elements are easily manufactured and mounted in the casing tube. A perforation in the heat conductor itself is not required, and it is also not necessary to texture the inner wall of the casing tube before introducing the spacer element into the tube cross section.

The disk is preferably made from carbon fiber-reinforced carbon (CFC).

It has proven satisfactory for the opening to include a portion of the circumference of the disk. By such a design for the spacer element, the heat conductor may be laterally inserted into the spacer element and thus can be installed more quickly.

It is also possible for the opening to be situated at a distance from the circumference of the disk. In this embodiment, however, the heat conductor must be threaded through the disk, thereby increasing the installation time.

It has proven satisfactory for the disk to have a thickness in the range of 0.5 to 5 mm.

Graphite, graphite film, or carbonized, graphitized CFC material is preferably used as material for the heat conductor.

It has proven satisfactory for the heat conductor to be adhesively attached in the opening, thereby preventing migration of the heat conductor in the disk. After the heat conductor and disk are bonded, volatile components are baked out of the adhesive used.

It is advantageous for the service life of the infrared radiation source when the casing tube is filled or evacuated with an inert gas or gas mixture.

In particular, it has proven satisfactory for the casing tube to have an elliptical cross section perpendicular to its longitudinal axis. Rotational movement of the heat conductor in the casing tube is thus automatically prevented, and a separate fixing of the disk in the casing tube as anti-rotation protection is not required.

If a casing tube is used which has a circular cross section perpendicular to its longitudinal axis, it is advantageous for the casing tube to be deformed in the region of the at least one spacer element. There is essentially no resulting change in the wall thickness of the casing tube.

Ideally, the inventive infrared radiation source is used at heat conductor temperatures in the range of 900 to 2200° C.

The object relating to the method is achieved by manufacturing an infrared radiation source having a casing tube with a circular cross section in such a way that the heat conductor together with the at least one spacer element is inserted into the casing tube, and the casing tube is subsequently deformed by applying heat to the casing tube in the region of the at least one spacer element, and the heated casing tube is deformed in such a way that the at least one spacer element fills the open cross section between the heat conductor and the casing tube.

Such a method is simple, quick, and economical, and weakening of the casing tube wall does not occur.

On its own, a heat treatment of the casing tube results in shrinkage of the inner diameter of the casing tube and adaptation to the at least one spacer element. In addition to heat treatment of the casing tube, the heated quartz glass may also be deformed by the use of optionally heated stamps.

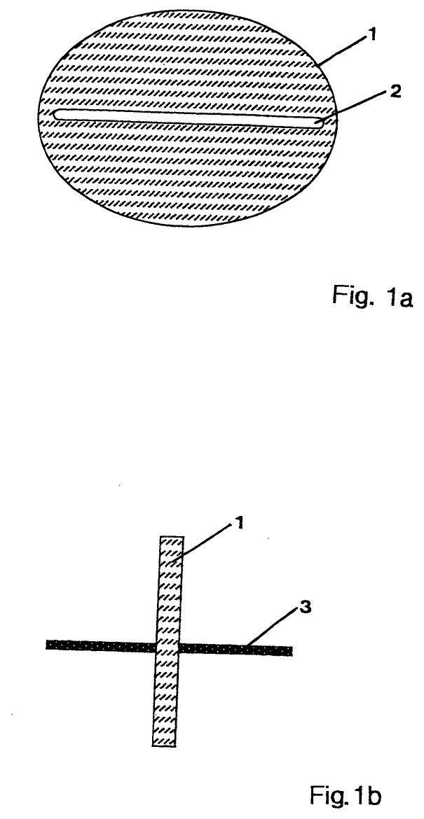

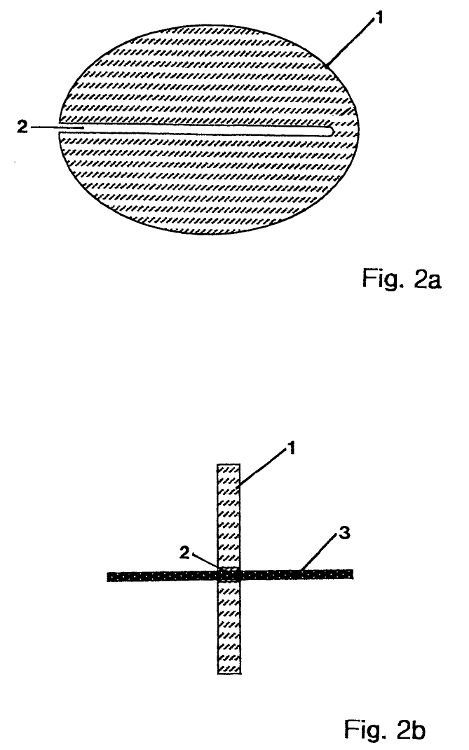

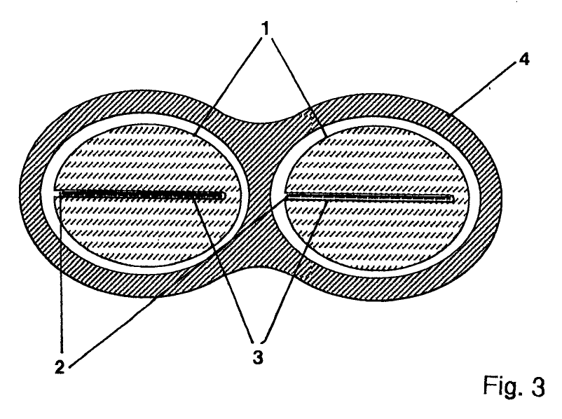

FIGS. 1a through 2b show suitable spacer elements for the infrared radiation source according to the invention, and FIGS. 3 through 5 show the inventive infrared radiation source itself.

FIG. 1a shows a spacer element which is designed as a disk made of carbon fiber-reinforced carbon;

FIG. 1b shows the spacer element from FIG. 1a in the side view, including a heat conductor which is passed through same;

FIG. 2a shows an additional spacer element made of carbon fiber-reinforced carbon;

FIG. 2b shows the spacer element from FIG. 2a in the side view with a heat conductor passed through same;

FIG. 3 shows the cross section through an infrared radiation source having twin casing tubes and spacer elements according to FIGS. 2a and 2b;

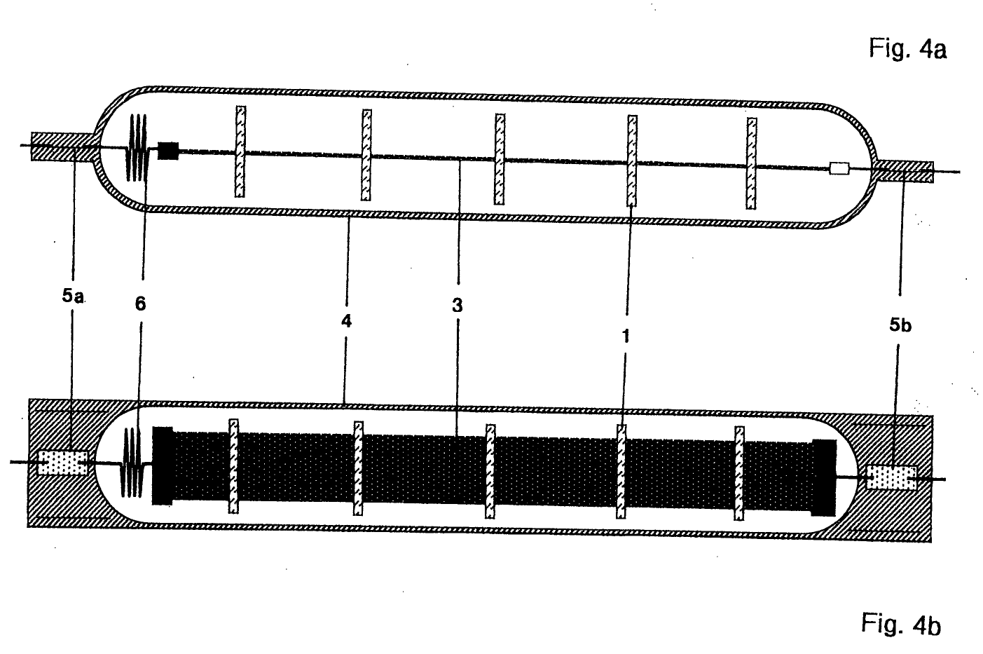

FIG. 4a shows an infrared radiation source having a casing tube which has a circular cross section, in the longitudinal section;

FIG. 4b shows the infrared radiation source from FIG. 4a in an additional longitudinal section; and

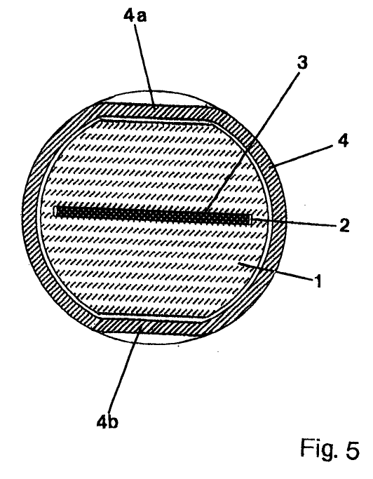

FIG. 5 shows a cross section through an infrared radiation source having a deformed casing tube.

FIG. 1a shows a spacer element 1 which is designed as a disk, whereby the disk has an opening 2 for passing the heat conductor through. The disk is made of carbon fiber-reinforced carbon (CFC).

FIG. 1b shows the spacer element 1 from FIG. 1a in the side view. A heat conductor 3 has been passed through the opening 2 (visible in FIG. 1a).

FIG. 2a shows an additional spacer element 1 made of carbon fiber-reinforced carbon (CFC) in which the opening 2 includes a portion of the circumference of the spacer element 1 designed as a disk.

FIG. 2b shows the spacer element 1 from FIG. 2a in the side view, a heat conductor 3 being situated in the opening 2.

FIG. 3 shows the cross section through an infrared radiation source having a casing tube 4 designed as twin tubes having elliptical cross sections and made from quartz glass. In each of the two channels a heat conductor 3 is respectively situated which is centered and held by disk-shaped spacer elements 1. The heat conductors are located in the openings 2 in the spacer elements 1.

FIG. 4a shows a cross section through an infrared radiation source having a casing tube 4 with a circular cross section. In the casing tube 4 a heat conductor 3 is situated which is centered and held in the casing tube 4 by spacer elements 1. The ends of the casing tube 4 are sealed gas-tight and are provided with current feedthroughs 5a, 5b. The heat conductor 3 is stretched by a tension spring 6, thereby preventing sagging of the heat conductor upon heating.

FIG. 4b shows the infrared radiation source from FIG. 4a in an additional longitudinal section which has been rotated 90° with respect to the illustration in FIG. 4a.

FIG. 5 shows a cross section through an infrared radiation source having a casing tube 4 with a circular cross section. In the casing tube 4 a heat conductor 3 is situated which is centered and held in the casing tube 4 by a spacer element 1. The heat conductor 3 is passed through an opening 2 in the spacer element 1. The spacer element 1 is designed as an out-of-round disk which together with the heat conductor 3 is introduced into the casing tube. Only after this occurs is the casing tube 4 heated and deformed in the region of the spacer element 1, so that a localized adaptation of the inner contour of the casing tube 4 to the spacer element 1 in regions 4a, 4b of the casing tube 4 is achieved as well. Rotational movement of the heat conductor 3 in the casing tube 4 is thereby effectively prevented, and the casing tube 4 is not weakened.

1. An infrared radiation source comprising a long, gas-tight casing tube made of quartz glass, and a heat conductor made of carbon which is situated in the casing tube, the heat conductor being electrically connected to at least two electrical contacts outside the casing tube and being situated at a distance from the casing tube by at least one spacer element and being centered therein, and the heat conductor is designed as a long strip, wherein the at least one spacer element is designed as a disk, whereby the disk has an opening for passing the heat conductor through, and the disk at least partially fills the open cross section between the heat conductor and the casing tube.

2. An infrared radiation source according to claim 1, wherein the disk is made of carbon fiber-reinforced carbon (CFC).

3. An infrared radiation source according to claim 1, wherein the opening includes a portion of the circumference of the disk.

4. An infrared radiation source according to claim 1, wherein the opening is situated at a distance from the circumference of the disk.

5. An infrared radiation source according to claim 1, wherein the disk has a thickness in the range of 0.5 to 5 mm.

6. An infrared radiation source according to claim 1, wherein the heat conductor is made of graphite, graphite film, or carbonized, graphitized CFC material.

7. An infrared radiation source according to claim 1, wherein the heat conductor is adhesively attached in the opening.

8. An infrared radiation source according to claim 1, wherein the casing tube is filled or evacuated with an inert gas or gas mixture.

9. An infrared radiation source according to claim 1, wherein the casing tube has an elliptical cross section perpendicular to its longitudinal axis.

10. An infrared radiation source according to claim 1, wherein the casing tube has a circular cross section perpendicular to its longitudinal axis, the casing tube being deformed in the region of the at least one spacer element.

11. A method comprising heating the heat conductor of the infrared radiation source of claim 1 to a temperature of from 900 to 2200° C.

12. A method for manufacturing an infrared radiation source according to claim 10, comprising inserting the heat conductor together with the at least one spacer element into the casing tube, and deforming said casing tube by applying heat to the casing tube in the region of the at least one spacer element until the at least one spacer element fills the open cross section between the heat conductor and the casing tube.
